(19) United States
(12) Patent Application Publication
(10) Pub. No.: US 2005/0254727 A1
(43) Pub. Date: Nov. 17, 2005

(54) Method, apparatus and computer program product for determining image quality

(75) Inventor: Elena A. Fedorovskaya, Pittsford, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/846,310

(22) Filed: May 14, 2004

(51) Int. Cl. G06K 9/62; G06K 9/46

(52) U.S. Cl. 382/286; 382/190

(57) ABSTRACT

A method and computer program product are provided for evaluating quality of an image. In accordance with the method a digital image is obtained and the digital image is analyzed using a first mental representation based upon a first level of human visual processing of an image to obtain a first perceptual image analysis measure. The digital image is also analyzed using a second mental representation based upon a second level of human visual processing of an image to obtain a second perceptual image analysis measure. An image quality evaluation measure is determined based upon the first perceptual image analysis measure and the second perceptual image analysis measure. The first and second mental representations are based upon different levels of human visual processing.

### FIELD OF THE INVENTION

The invention relates to the field automatic image processing, and more specifically to the automatically determining a perceived quality of images.

### BACKGROUND OF THE INVENTION

Rapidly growing numbers of applications and services related to digital imaging and digital photography emphasize the output image quality as one of their most important product attributes. Delivery of these applications and services require the development of elaborate image processing techniques to maintain and, if necessary, enhance the perceived image quality of each individual image. An intelligent image processing system, that can selectively apply specific image processing or image enhancement techniques to any given image can potentially save processing time associated with the application of image processing algorithms, and can improve customer satisfaction by enhancing the perceived quality of pictures that will benefit from this processing. Predicting perceived quality from image data in an automatic fashion, and determining a particular image characteristic or attribute that may need improvement, therefore becomes an increasingly important part of such an intelligent imaging system.

There currently exist several directions in pictorial image quality research that were initially developed for specific purposes. These approaches are usually implemented in conjunction with certain experimental methods and empirical models used to explain the data. Among them we can differentiate.

Psychophysical or Psychometric Approach

Within this approach, subjective image quality judgments and their biases became the main subject of investigation. This work was pioneered by Eastman Kodak Company researchers: MacAdam (D. L. MacAdam, Proceedings Institute of Radio Engineers, 36, 468, 1951) and Bartleson (C. J. Bartleson, J. Photographic Science 30, 33, 1982) and further developed by other researchers (J. Roufs, Philips Journal of Research, 47, 35, 1992; B. W. Keelan, “Predicting Multivariate Image Quality from Individual Perceptual Attributes”, Proceedings PICS, pg. 82, 2002).

A central premise of this research is that perceived attributes can be measured using perceptual scaling techniques and that a relationship may be derived to explain the connection between a physical or system parameter and the perceptual scale. Image quality is then understood as an aggregate of perceived image attributes.

System-Based Approach

The goal of this approach is to establish a set of specific system parameters to attain reproduction aims. According to this approach parameters that describe the performance of a capture or a reproduction imaging system are set to produce images according to the defined specification. Image quality is then regarded as a certain quantifiable level of such performance. Usually this approach considers a single aim or a few aims that would satisfy a broad range of images, and thus characterizes the system performance in terms of the perceived quality of an average or representative set of images. The approach has proven to be a useful tool for optimization of various system parameters. The main challenges of this approach are: a scene dependency, because aims for the images of different scenes could be different (example, a portrait image compared to a scenic image), and a system dependency: a new reproduction method or a system that incorporates novel technical solutions, brings new parameters that may require the reassessment of the system performance. For example, a tone-reproduction curve, as a system parameter relevant to the system contrast, could be replaced by the scene-dependent tone scale. This process produces results difficult to predict, based on the concept of the tone scale as a smooth monotonic function and related concept of an input image as an average image for the on-aim photography.

Signal Processing Based Approach

This approach originated from the need to measure and compare physical or technical properties (e.g., resolution, bit depth, noise, histogram, compression rate, quantization error, etc.) of digital images and image transformations (filtering, sampling, interpolation, etc.) with respect to output quality. Because these properties are not directly related to the observer's “psychological reality,” their estimation originally did not include observer's perception. This methodology is a broadening of the signal processing approach. An image is thus considered to be a complex signal, and image quality is treated as a measure of this signal. From this, such metrics as signal-to-noise ratio, root-mean-square error, etc., were derived and used with respect to image quality. Within the context of this approach, a human observer is implicitly understood as another technical device that captures and registers physical complex signals. Although useful in specific instances, this paradigm is limited in its capability for generalization.

A Low Vision-Based Approach

This approach, commonly referred to as vision modeling was pioneered during the early 1990's (see S. Daly, “The Visible Differences Predictor: an Algorithm for the Assessment of Image Fidelity”, in A. Watson (ed.), Digital Images and Human Vision, MIT Press, Cambridge, Mass., 1993, pg. 179; J. Lubin, “A Visual Discrimination Model for Imaging System Design and Evaluation”, in E. Peli (ed.), Vision Models for Target Detection, World Scientific, Singapore, 1995, pg. 245), and has received significant attention since (A. B. Watson and J. Malo, “Video Quality Measures Based on the Standard Spatial Observer”, Proceedings ICIP, IEEE, pg. 111-41, 2002). It originated from the need to assess threshold level changes in an image due to processing techniques, such as image compression, filtering, sampling, etc. This approach can be considered as an integration of low-level vision data obtained in psychophysics to enable differential response for complex images. The output of the visual model-based algorithm could be described as a measure of visual difference between a reference image and an image under consideration. Although the vision model-based approach has demonstrated important successes in simulating low level visual processes, its main challenges, with respect to image quality, are associated with difficulties in formulating a combination metric that allows for the integration of spatially localized difference maps into a single visually adequate global measure of visual difference, and the absence of a clear relationship between absolute visual difference and image quality. Because it is impossible to infer which image from a pair of images has higher quality considering only a visual difference map, the image quality concept within this approach is reduced to the concept of image fidelity with a crucial role of the reference image, frequently understood as having optimal quality. In addition, higher-level visual processes, which have not yet been incorporated into these models (e.g., constancy, attention, subjective importance of different regions of the image), may significantly influence the judgment of the visual difference and, consequently, the predictive power of the model.

Information Processing Approach

A very novel and powerful approach was recently proposed in an attempt to explain experimentally observed discrepancy between judgments of naturalness and quality preferences (H. de Ridder, Imaging Science and Technology, 40, 487, 1996; E. A. Fedorovskaya, H. de Ridder, and F. J. J. Blommaert, Color Research Application, 22, 96, 1997; S. N. Yendrikhovskij, F. J. J. Blommaert, and H. de Ridder, “Towards Perceptually Optimal Colour Reproduction of Natural Scenes”, in L. W. MacDonald and R. Luo (ed.), Colour Imaging: Vision and Technology, 1999, pg. 363). This approach emphasizes visual information processing in understanding and modeling of perceived image quality (R. Janssen, Computational Image Quality, SPIE Press, Bellingham, Wash. USA, 2001). Assuming that visual processing of images is a goal-directed process, and stressing its active nature from the observer's stand point, the suggested approach formulates image quality as the degree of the adequacy of the image as input to the vision stage of the interaction process. Two requirements are proposed in considering this adequacy: discriminability and identifiability of the image content. The fruitfulness of this paradigm was demonstrated by developing computational methods to define colorfulness, naturalness and quality for images subjected to global variations along perceptual dimensions in color space (S. N. Yendrikhovskij, F. J. J. Blommaert, and H. de Ridder, “Towards Perceptually Optimal Colour Reproduction of Natural Scenes”, in L. W. MacDonald and R. Luo (ed.), Colour Imaging: Vision and Technology, 1999, pg. 363). It was not clear, however, how the particular implementation of this approach if strictly followed could lead to predicting quality of an arbitrary image from an arbitrary source.

The provided classification is relative, in a sense that often there is a combination of the approaches in any given investigation. However, they still can be recognized by their primary focus and applied methods. A very useful way to visualize their specialty could be derived from the diagram of Image Quality Circle suggested by Engeldrum (P. G. Engeldrum, “Image Quality Modeling: Where Are We?”, Proceedings PICS, pg. 251, 1999), if one could imagine a short link to quality determination from the appropriate blocks in the circle that denote components of the chain that relate technology variables (system parameters) of the imaging system to resulting customer quality preferences.

Below we describe the paradigm that could be utilized to integrate advantages and unique knowledge obtained through various approaches. The paradigm is very closely related to the information processing approach suggested by Janssen (R. Janssen, Computational Image Quality, SPIE Press, Bellingham, Wash. USA, 2001). However, rather then considering information processing in general, we would like to make a main emphasis on the understanding of vision process as a structure of multiple levels of mental representation, a notion that allows us to more fully explore perceptual properties of images with respect to image quality.

Computational Vision as a Paradigm Toward Image Quality

Computational vision is a multidisciplinary field that integrates a number of disciplines: neurophysiology, psychology, and artificial intelligence, which considers vision as a computational process and “emphasizes information, knowledge, representation, constraints, and processes, rather than details of mechanisms” (H. G. Barrow, and J. M. Tenenbaum, “Computational Approaches to Vision”, in: K. R. Boff, L. Kaufman, and J. P. Thomas, (eds.) Handbook of Perception and Human Performance. Volume II, Cognitive Processes and Performance, John Wiley and Sons, New York, 1986). Within the computational approach to vision that is described in a number of papers (H. G. Barrow, and J. M. Tenenbaum, “Computational Approaches to Vision”, in: K. R. Boff, L. Kaufman, and J. P. Thomas, (eds.) Handbook of Perception and Human Performance, Volume II, Cognitive Processes and Performance, John Wiley and Sons, New York, 1986; D. Marr, Vision, San Francisco: Freeman, 1982), a vision system is often structured as a succession of levels of representation. The initial levels are constrained by what is possible to compute directly from the image, while higher levels deal with the information required to support the ultimate goal. The order of representation is constrained by what information is available at preceding levels and what is required by succeeding levels. For example, the sensing process, taking place in early vision, leads to conversion from light flux incident on a photosensitive receptor array to a brightness measurement by the photosensing mechanism often involving spatial quantization. The next stage of processing attempts to detect spatial and temporal changes such as discontinuities in brightness or brightness gradient, line ending or local anomalies in a homogeneous field, in the image and to make them explicit. The output representation is an array with feature description recorded at each location. Marr's raw primal sketch is an example of a suitable representation for image features (D. Marr, Vision, San Francisco: Freeman, 1982). The raw primal sketch uses three kinds of primitives to describe intensity changes: various types of edge, lines or thin bars, and blobs. Each is characterized in terms of orientation, size (length and width, or a blob's diameter), contrast, position, and termination points.

The local edge and blob description in the raw primal sketch must be organized into spatially coherent units (e.g., boundaries and regions) for subsequent analysis. Some basic grouping processes occur at this stage; organizing elements into straight lines and smooth curves, and to cluster elements into regions of textures. This stage corresponds to what Marr denoted as a full primal sketch.

Palmer (S. Palmer, Vision Science: Photons to Phenomenology, The MIT Press, Cambridge, Mass., 1999), using Marr's theoretical framework as a foundation, decomposed visual perception at the algorithmic level into four major stages beyond the retinal image itself. Each stage is defined by a different kind of output representation and the processes that are required to compute it from the input representation. Applying the labeling scheme from the information processing approach, each stage is. named according to the kind of information it represents explicitly: the image-based, surface-based, object-based, and category-based stages of perception.

The computational vision approach seems to be a powerful paradigm for understanding and modeling perceived image quality. The fruitfulness of the information processing approach to computationally define image quality and naturalness has already been demonstrated by Endrikhovski and Janssen (S. N. Yendrikhovskij, F. J. J. Blommaert, and H. de Ridder, “Towards Perceptually Optimal Colour Reproduction of Natural Scenes”, in L. W. MacDonald and R. Luo (ed.), Colour Imaging: Vision and Technology, 1999, pg. 363; R. Janssen, Computational Image Quality, SPIE Press, Bellingham, Wash. USA, 2001).

What is needed therefore is a way to implement a computational vision framework, which will overcome major limitations of the existing approaches to image quality, namely, algorithm dependency, system dependency, and scene dependency, by considering image properties relevant to appropriate levels of mental representations of a scene. What is also needed is a way of expressing and measuring the scene in terms of the identified properties and their adequacy to human visual and cognitive processes responsible for constructing above-mentioned mental representations.

### SUMMARY OF THE INVENTION

In various aspects of the invention, a method and computer program product are provided for evaluating quality of an image. In accordance with the method a digital image is obtained and the digital image is analyzed using a first mental representation based upon a first level of human visual processing of an image to obtain a first perceptual image analysis measure. The digital image is also analyzed using a second mental representation based upon a second level of human visual processing of an image to obtain a second perceptual image analysis measure. An image quality evaluation measure is determined based upon the first perceptual image analysis measure and the second perceptual image analysis measure. The first and second mental representations are based upon different levels of human visual processing.

In other aspects of the invention a method and computer program product are provided for evaluating quality of a digital image. In accordance therewith, a set of perceptual image analysis representations are determined to be used in evaluating an image with each perceptual image analysis representation being based upon a different level of human image perception and a set of image elements are identified for use in analyzing the image with respect to each perceptual image analysis representation. Objectively measurable image features of the identified elements are obtained and the features obtained for each determined perceptual image analysis representation are analyzed to determine an image quality measure for each perceptual image analysis representation. An overall image analysis measure is determined based upon the determined image quality measures

### BRIEF DESCRIPTION OF THE DRAWINGS

FIG. 1 shows a flow diagram of a first embodiment of a method of the invention;

FIG. 2 shows a flow diagram of a second embodiment of the method of the invention; and

FIG. 3. shows a flow diagram of a third embodiment of the method of the invention;

### DETAILED DESCRIPTION OF THE INVENTION

The present invention provides a structure and method for estimating image quality in terms of an image quality measure. To this end objective information is extracted from an image by systematically considering properties of an image relevant to the steps of information processing in the human visual system and corresponding levels of mental representations of the scene. Some of those levels are array representation, image-based representation, surface-based representation, object-based representation, category-based representation. The (saliency) features, extracted from the image are expressed as measures for pixels distribution, edge characteristics, region characteristics, depicted objects' characteristics, as well as their relationship to the prototypical (categorical) characteristics of the corresponding object category.

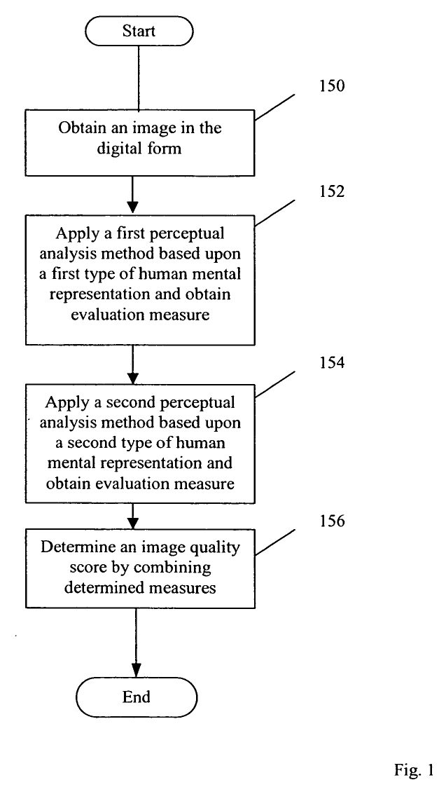

Referring now to FIG. 1, what is shown is a flowchart illustrating one embodiment of the invention. As shown in step 150, an image is received in digital form. This can be done in a variety of ways including but not limited to capturing a digital image of a scene, converting a previously captured image into digital form, and/or receiving a digital image from a source such as a computer, digital camera, personal digital assistant, cellular telephone, cellular telephone network, wired or wireless communication system or the like.

The digital image is then analyzed using a first mental representation based upon a first level of human visual processing to obtain a first perceptual image analysis measure (step 152). The following assumptions can be used in defining different levels of mental representation (also referred to herein as different stages of mental representation) for use in digital image analysis and in determining an overall image quality measure for an image:
1) Judgments of perceived image quality, as well as overall attributes (e.g., overall contrast, overall lightness, colorfulness, etc.), are derived by assessing the image using mental representations that can be analyzed with respect to a set of corresponding image elements.
2) Perceived image quality and perceived overall attributes, as related to the integral impression from the image, may involve elements from multiple levels (or stages) of mental representation.
3) The elements relevant to the perceived attributes and quality can be computationally evaluated and, therefore, the prediction of perceived attributes and quality can be calculated.
4) In perceived quality and attribute predictions, the elements measured can be combined.

By assessing the image using multiple different levels of mental representation, the existing problems of scene, algorithm, and system dependency, with respect to image quality modeling can be solved.

In principle, all perceptually, and broadly, psychologically-defined mental representations can be considered in this model. Mental representations such as mental representations that are based upon a sensory array (a.k.a. retinal image, input image, intensity image, or color array) stage, image-based stage, surface-based stage, object-based stage, and/or category-based stage of human visual perception described in (S. Palmer, Vision Science: Photons to Phenomenology, The MIT Press, Cambridge, Mass., 1999) can be used. Additionally, other kinds of mental representations can also be used including but not limited to mental representations that are emotionally related, symbol, or metaphor-related.

In accordance with the invention, each level of mental representation is associated with particular image elements that characterize events at a stage of visual processing. For example, in sensory array level representation, elements can comprise array elements that are considered both in a spatial and frequency domain. Other examples of elements include, edges, lines, or regions that can be used for an image-based level mental representation; local patches of 2D surface at some slant, located at some distance that can act as elements for a surface-based mental representation and volumetric primitives that can be used as elements for an object-based representation. It will be appreciated that other levels of mental representation with other associated elements can be used.

Elements can be associated with a number of descriptors, for example, size, orientation, contrast, position, as well as statistical descriptions. These descriptors will be referred to herein as features. Features are automatically analyzed using algorithms that are relevant to mental representation. In accordance with the invention, the features are analyzed to determine a first perceptual image analysis measure.

For the purposes of illustration, the first mental representation used in step 152 can comprise a sensory array mental representation. The sensory array mental representation can be achieved using a vision model of low level visual processing to transform an image, comprised of pixels, into a “sensory array” representation. In another embodiment, this approach can be approximated by describing image pixels in CIELAB color space, with the expectation that this approximation would be sufficient in certain embodiments. The array representation in the spatial domain can be analyzed to extract features that include, for example, descriptive statistics for CIELAB pixel distributions of lightness, chroma, and hue angle, such as statistical moments: mean, standard deviation, skewness and kurtosis, other statistics, such as maximum and minimum values. Where one mental representation is used having multiple features associated with it, the features can be combined in any of a number of ways to derive a first perceptual analysis measure for the image.

For example, a range contrast feature can also be calculated for an image using the formula for Michelson contrast, expressed as a ratio of the difference between maximum and minimum lightness values to their sum. To minimize computation time, all these features can be calculated for a low-resolution version of the images obtained by averaging blocks of 8×8 pixels and scaling down the image. For the frequency domain, features such as the energy in various frequency bands, as well as ratios or other combinations, can be computed using an original, high-resolution image. These features are then combined to determine a first perceptual analysis measure that is based upon a sensory level analysis for the image.

The obtained digital image is then analyzed using a second mental representation based upon a second level of human visual processing of an image to obtain a second perceptual image analysis measure (step 154). The second mental representation used in step 154 is different from the first mental representation used in step 152.

For purposes of corresponding to the illustration in step 154, a second mental representation corresponding to a second level of human visual processing of an image is used, for example, an image-based stage of human visual processing. Using this second mental representation, edge-related and region-related descriptors are used. One such description could be an edge contrast feature which can be approximated by the standard deviation of lightness differences between adjacent pixels of the low-resolution image. Other edge characteristic features can be determined from the full-resolution image. In this case, an edge detection method can be used to first identify edges. In order to locate edges in an image, several standard edge detection methods can be employed. In the preferred embodiment the Canny's edge detection algorithm was used. This algorithm is described in an article entitled “A Computational Approach to Edge Detection”, published in IEEE Transactions on Pattern Analysis and Machine Intelligence, 8, pp. 769-798, 1986 by J. F. Canny. For all edge pixels edge height, edge gradient and edge width were computed. Mean and maximum values for all of these characteristics were used as features. Another descriptor, the color area contrast feature is computed as the average pair-wise difference between mean CIELAB values for the regions multiplied by the number of regions identified in the image.

The regions can be obtained by applying an image segmentation algorithm to a low-resolution version of the image if preferred, one example of which is described in J. Luo, R. T. Gray, and H. C. Lee, “Towards Physics-based Segmentation of Photographic Color Images, Proceedings IEEE International Conference Image Process., 1997.

After the relevant features for an image have been determined, an image quality measure can be determined for image-based stage of human visual processing based upon the features.

It will be appreciated that any number of additional perceptual analysis algorithms can be applied to obtain any additional number of perceptual image analysis measures.

Finally, in step 156, an image quality measure is computed by combining the measures calculated in steps 152 and 154. There are a variety of possible combination rules that can be applied to combine the features, for example, Minkowski metric with different exponents. The linear summation is the simplest combination rule, which is used in the preferred embodiment of the present invention. In this case, if Φ=F₁, . . . , Fₙ is the set of measurements performed for the corresponding n features, and A=A₁, . . . , Aₘ—a set of m overall image attributes, then A=Φ·B, where B is the n×m—matrix of weights, assigned to those features. Alternatively, a weighted linear or other weighted combination rule, including non-linear combinations, can be applied so that one or more of the perceptual image analysis measures can be determined.

The choice of a particular numerical way for the feature assessment was driven by “visual” sense and simplicity considerations. In other embodiments each feature assessment can be refined and tied to psychophysically established data collected from a pool of expert viewers.

This approach for assessing overall perceived image quality, as well as other attributes based on above described analysis of image information, was validated in a series of experiments. In these experiments, subjects evaluated overall quality, contrast, sharpness, lightness, and colorfulness of color images of natural scenes. Subsequently, their judgments were compared with the measurements of features extracted from the observed images.

To this end one hundred twenty six (126) images were chosen for the experiments, representing a variety of scenes, such as indoor and outdoor pictures, different seasons, people in groups and close-up portraits, animals, and images taken under different lighting conditions (e.g., flash, bright sun, twilight, shadows, etc.). The images varied in their quality and attribute strength as a result of problems at capture (e.g., an indoor picture with an electronic flash) or because of specific scene characteristics (e.g., a backlit scene or misty conditions).

The viewers were asked to rate overall quality and overall perceived image attributes, such as overall contrast, overall lightness, overall colorfulness, overall sharpness, and main subject sharpness.

The following definitions were provided to the subjects: Perceived Overall Contrast was defined as an integrated impression of differences in lightness, or lightness variation observed within the whole picture.

Overall Sharpness was the overall impression of clarity of edges observed within the whole picture.

Overall Colorfulness was defined as the impression of presence and vividness of colors in the whole picture.

Overall Lightness was defined as the impression of the lightness level that an image produces.

Perceived Quality was defined as the degree of excellence of the reproduction.

Main Subject Sharpness was defined as the overall impression of clarity of edges on the primary subject.

In the experiment, image quality was modeled on the basis of feature selection. For feature selection representations relevant to the sensory stage and image-based stage were considered. Although, ideally, a vision model of low level visual processing could be used to transform a physical image, comprised of pixels, into a “sensory array” representation, for the practical purposes of simplification, this representation was approximated by describing image pixels in CIELAB color space, with the expectation that this approximation would be sufficient in demonstrating the applicability of the computational vision approach to image quality.

For the sensory array representation in the spatial domain features that included descriptive statistics for CIELAB pixel distributions of lightness, chroma, and hue angle were used. Statistical moments: mean, standard deviation, skewness and kurtosis, other statistics, such as maximum and minimum values, were among the features, as well as their combinations. For example, a range contrast feature was calculated using the formula for Michelson contrast, expressed as a ratio of the difference between maximum and minimum lightness values to their sum.

To minimize computation time, all these features were calculated for the low-resolution images obtained by averaging blocks of 8×8 pixels and scaling down the image. For the frequency domain, energy in various frequency bands, as well as ratios were computed using the original, high-resolution image.

For the image-based stage, edge-related and region-related descriptors were specified. Edge contrast feature was approximated by the standard deviation of lightness differences between adjacent pixels of the low-resolution image. The color area contrast feature was computed as the average pair-wise difference between mean CIELAB values for the regions multiplied by the number of regions identified in the image.

For the purpose of the experiment, regions were obtained by applying an image segmentation algorithm as described above, and other edge characteristics were determined from the full-resolution image, again as described above. During experimentation, the choice of a particular numerical way for the feature assessment was driven by “visual” sense and simplicity considerations. It is obvious, however, that in other embodiments each feature assessment can be refined and tied to psychophysically established data collected from a pool of expert viewers.

The suitability of the linear summation described above was determined based on the analysis of experimental results using a stepwise linear regression procedure for data fitting. The features contributing to perceived quality and attribute predictions are listed in Table 1. As shown in this table, there are total of thirteen different features identified as significant. While four features contribute to only one attribute, e.g., mean lightness for overall lightness prediction or edge width for sharpness, other features systemically appear in the regression equations for many attributes. The overlap in the feature sets predicting different attributes, may be used to explain the empirically known observation that some attributes correlate with each other.

TABLE 1
Feature contribution to perceived attributes.

| | | | | Color- | |
|---|---|---|---|---|---|
| Feature | Contrast | Lightness | Sharpness | fulness | Quality |
| Maximum lightness | + | + | + | + | + |
| Maximum chroma | + | + | | + | + |
| Mean lightness to | + | | + | | + |
| background distance | | | | | |
| Mean lightness | | + | | | |
| Range contrast | + | + | + | + | + |
| Standard deviation of | | + | | + | |
| chroma | | | | | |
| Spatial frequency band rartio | | + | + | | + |
| Edge contrast | + | | | | |
| Edge hue difference | | | | + | |
| Maximum edge gradient | | + | + | | + |
| Mean edge gradient | + | | + | + | + |
| Edge width | | | + | | |
| Color area contrast | + | | + | | |
| R squared | 0.77 | 0.72 | 0.64 | 0.85 | 0.57 |

Comparing the coefficient of determination (R²) measure obtained for different attributes, one can notice that overall sharpness and, especially, quality turned out to be the most difficult to predict attributes: 0.64 for the sharpness prediction and 0.57 for the quality prediction, respectively.

Based on this, the following example formula can then be derived and used to obtain the image quality measure:
Image Quality Score=−1.39*maximum Lightness+0.12*maximum Chroma+0.37*mean Lightness background+0*mean Lightness+63.67*range contrast+0.43*standard deviation Chroma+8.19*spatial frequency band ratio+0*edge contrast+10.86*mean edge gradient+0*edge hue difference+0.32*maximum edge gradient+0*edge width+0*color area contrast;
   where the maximum Lightness is estimated as the maximum value for pixels' L*, maximum Chroma is the maximum CIE 1976 C* for the pixels, mean Lightness background is computed as the absolute value of average L* less 50; mean Lightness denotes the average L* of the pixels' distribution; range contrast is calculated as the (maximum L*−minimum L*)/(maximum L*+minimum L*); standard deviation Chroma corresponds to the standard deviation of the C* pixel values; spatial frequency band ratio designates the ratio energy in spatial frequency bands (in this case it compares the energy in two adjacent frequency bands: 9-7 cycles per degree of visual angle and 6-4 cycles per degree of visual angle); edge contrast is approximated by the standard deviation of lightness differences between adjacent pixels of the low-resolution image; mean edge gradient and maximum edge gradient represent average gradient and maximum gradient for edge pixels; edge hue difference is computed similarly to the edge contrast, however instead of the lightness differences, the hue angle differences between adjacent pixels are used; edge width is the distance between pixel positions corresponding to the pixels with the maximum and minimum L* values; the color area contrast is computed as the average pair-wise difference between mean CIELAB values for the regions multiplied by the number of regions identified in the image.

Using this analysis some images can be under- and over-predicted. One factor that might in part cause this is a need for better quality feature extraction methods for use with some types of images and mental representations. However, it has been learned that adjustments in the apparent importance of the characteristics of the main subject rendering for assessing perceived quality and overall sharpness, is the most critical attributes that might impact. The examination of the outliers for those predictions largely supported the latter supposition. Some of those images had the main subject not in focus (e.g., a close-up of a person's face), while the rest of the picture was sharp. This assumption was tested by allowing the main subject sharpness assessment obtained in the experiments to be a candidate predictor during regression modeling. The main subject sharpness information was found to considerably improve model predictions for several attributes, including sharpness, contrast, and quality.

At the same time, the majority of previously identified features were still significant. For example, for overall sharpness, prediction adding main subject sharpness to a predictor list increased the R² value from 0.77 to 0.89. At the same time, 7 out of 8 previously determined features retained their significance, while only a maximum edge gradient dropped out. Analogous results were obtained for the quality prediction: the goodness of fit of the linear model improved to reach the R² value of 0.82, and, yet, 5 out of 7 initially selected features were still present in the resulting predictive combination. This indicates that the main subject sharpness assessment contained important and unique information, which was not directly extracted from the list of computed features designed to represent an entire image.

In the case of quality, the contribution of the main subject sharpness assessment was very substantial: this measure alone accounted for almost 70 percent of the variance. The latter observation points out that the sharpness of the main subject is a prevalent attribute determining quality, and the algorithmic identification of the main subject is necessary for more precise prediction, especially when parts of an image are out of focus or have other types of problems. Such identification can be done using the algorithms designed to detect main subject of a photograph. One such algorithm is disclosed in commonly assigned U.S. Pat. No. 6,282,317 B1 by Luo et al., the disclosure of which is incorporated herein by reference. This method automatically detects main subjects in photographic images by identifying object related properties, such as flesh, face, sky, grass, etc. as the semantic saliency features together with the “structural” saliency features related to color, texture, brightness, etc., and then combining those features to generate belief maps.

Another useful image processing technique for selecting areas for further acceptability determination disclosed in commonly-assigned U.S. Patent Publication No. U.S. 2002/0076100A1, entitled “Image Processing Method for Detecting Human Figures in a Digital Image”, filed on Dec. 14, 2000 by Luo et al., the disclosure of which is incorporated herein by reference. This method provides detection of human figures in a digital color image. The algorithm first performs a segmentation of the image into non-overlapping regions of homogeneous color or texture, with subsequent detection of candidate regions of human skin color and candidate regions of human faces; and then for each candidate face region, constructs a human figure by grouping regions in the vicinity of the face region according to a pre-defined graphical model of the human figure, giving priority to human skin color regions. In other embodiments, the object-related properties of the image, including the main subject of the image, could be defined interactively. In this case, the user manually outlines objects of the scene displayed on the screen of the imaging device using mouse, stylus or a finger for a touch screen.

Any other known method for determining a main subject of an image or an area of importance in an image can also be used.

It is worth noting, however, that in many instances, features that are not specifically related to the main subject, but instead, describe the entire image may work well: when an image does not have local problems, or the main subject amounts to the entire image, as in the case of a landscape, etc.

The experimental results described above are provided for the purposes of illustration and are not limiting. These results demonstrate a correlation between the predictions of quality obtained when one embodiment the method of the invention is applied to a set of images and the subjective opinions of people who have viewed the same set of images. It will be appreciated that a more refined formula can be derived when certain conditions are met such as where the opinions of a larger pool of users are studied for example using statistical methods and where the image set evaluated by the users is systematically adjusted to reflect a broad base of scene types.

In the experiments the consideration of the higher level representations, e.g., object and category levels, and constraints imposed on image quality were not elaborated. However, such levels of human visual perception characteristics are very important constituents of image quality. Incorporating the knowledge about higher level visual processing in a greater detail, image quality constraints, as well as further computational refinement of features at the lower levels could be done based on the above proposed framework.

For example, the category based level of mental representation into image quality measure by considering the perceived distance of the particular rendition of the object observed in an image compared to the typical rendition of the object remembered from the user's real-life experience. Consequently, in the alternative embodiment, such as distance expressed as the difference between the CIELAB coordinates for the actual depicted object or objects and the CIELAB coordinates of the remembered typical object rendition can be added to the linear summation equation to determine image quality score. The CIELAB specifications for several, most important typical object renditions as they are normally remembered by the viewers can be found in S. N. Yendrikhovskij, F. J. J. Blommaert, and H. de Ridder, “Towards Perceptually Optimal Colour Reproduction of Natural Scenes”, in L. W. MacDonald and R. Luo (ed.), Colour Imaging: Vision and Technology, 1999, pg. 363.

Thus, the results of the experiments demonstrate that the computational vision approach as described herein, appears to be a useful paradigm to further advance the development of image quality modeling and solve the problems that traditional approaches encountered. Accordingly, perceived image quality and image attributes can be systematically described using a combination of features computationally extracted from the image data, where features describe the relevant elements corresponding to the various levels of mental representation which are produced by a human visual system.

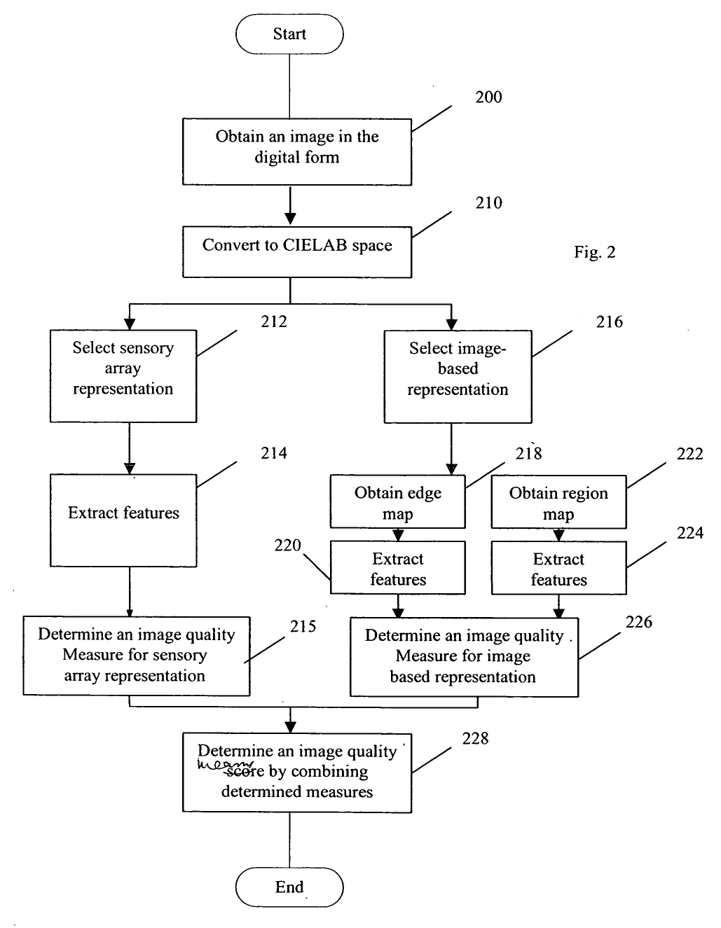

Referring now to FIG. 2, the use of the method illustrated in FIG. 1 is shown in greater detailed in application to various images. More specifically, in step 200 an image is obtained and in step 210 the digital image is converted from the digital input format, such as typical r, g, b format to the CIELAB values. Next, the sensory array is chosen as the first type of mental representation for the analysis (step 212) and several features relevant to this level are extracted (step 214) as described above. The features include such measures as, for example, maximum and mean lightness (L*), absolute deviation of average image lightness from the background L* value of 50, maximum chroma (C*) and standard deviation of chroma, range contrast and spatial frequency band ratio. An image quality measure for the sensory array representation is then determined (step 215).

Following the invention, an image-based type representation is considered in step 216. Subsequently, the image is subjected to the edge detection algorithm to create an edge map (step 218) and segmentation algorithm to create a region map (step 220) by applying the Canny edge detection method and an unsupervised image segmentation method as described above. These maps are used to extract relevant features, which describe edges and regions in the image (steps 222-224). The example of the feature set includes edge contrast, mean edge gradient, maximum edge gradient, edge hue difference, and edge width—for the edge map; and the color area contrast for the region map. Although in the preferred embodiment two types of mental representations are considered, in the alternative embodiments other types of representation can be analyzed. For example, surface-, object-, or category-based representations can be considered either in addition or instead of the two types described in steps 212 and 216. An image quality measure for the image based representation is then determined (step 226).

Finally, the combined image quality measure is calculated by linear summation of determined individual measures (step 228).

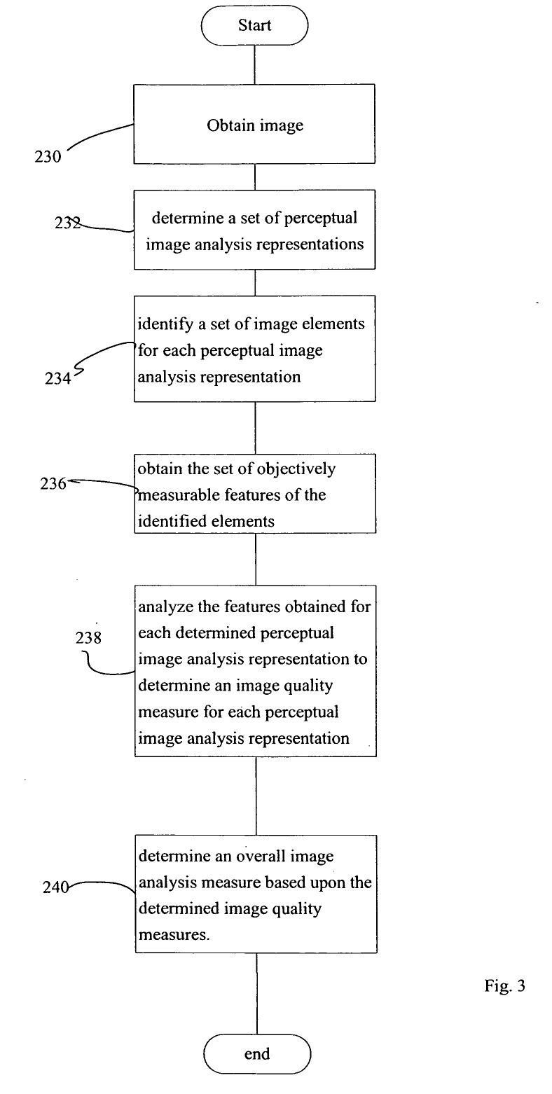

FIG. 3 shows still another embodiment of the invention. In accordance with this embodiment, an image is obtained (step 230) and a set of perceptual image analysis representations are determined for use in evaluating an image (step 232) with each perceptual image analysis representation being based upon a different level of human image perception. In accordance with this embodiment the set of perceptual image analysis representations to be used can be automatically established, can be based on a user input and/or can be preprogrammed. It will be appreciated that where the set is automatically or manually defined, it is possible to dynamically adjust the set of representations used so to improve efficiency and/or accuracy as needed in a particular application.

A set of image elements is identified for use in analyzing the image with respect to each of the perceptual image analysis representation in the set (step 234) and objectively measurable image features of the identified elements are obtained from the digital image (step 236). In this embodiment, each perceptual image analysis representation is associated with a predetermined set of features. Each feature can be associated with an algorithm defining how the feature is to be obtained from the digital image and wherein this is done, the step of obtaining the objectively measurable image features can execute the algorithms that define how the features are to be measured.

The features obtained for each determined perceptual image analysis representation are analyzed to determine an image quality measure for each perceptual analysis level (step 238) and an overall image analysis measure based upon the determined image quality measures (step 240).

In describing the present invention, it should be apparent that the present invention is preferably utilized on the digital imaging system that processes digital images, such as a personal computer. Consequently, the computer system will not be discussed in detail herein. It is also instructive to note that the images are either directly input into the computer system (for example by a digital camera) or digitized before input into the computer system (for example by scanning an original, such as a silver halide film).

In the preceding description, the embodiment of the present invention have been described as methods. However, in another embodiment, the present invention comprises a computer program product for evaluating the quality of an image. In describing the present invention, it should be apparent that the computer program of the present invention can be utilized by any well-known computer system. However, many other types of computer systems can be used to execute the computer program of the present invention. Consequently, the computer system will not be discussed in further detail herein.

The computer program for performing the method of the present invention may be stored in a computer readable storage medium. This medium may comprise, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program. The computer program for performing the method of the present invention may also be stored on computer readable storage medium that is connected to the image processor by way of the Internet or other communication medium. Those skilled in the art will readily recognize that the equivalent of such a computer program product may also be constructed in hardware.

The invention has been described in detail with particular reference to certain preferred embodiments thereof, but it will be understood that variations and modifications can be effected within the spirit and scope of the invention.

1. A method for evaluating quality of an image, the method comprising the steps of:
obtaining a digital image;
analyzing the digital image using a first mental representation based upon a first level of human visual processing of an image to obtain a first perceptual image analysis measure;
analyzing the digital image using a second mental representation based upon a second level of human visual processing of an image to obtain a second perceptual image analysis measure; and
determining an image quality evaluation measure based upon the first perceptual image analysis measure and the second perceptual image analysis measure,
wherein the first and second mental representations are based upon different levels of human visual processing.

2. The method of claim 1, wherein the first level mental representation is based upon at least one of the object and category levels of human visual perception.

3. The method of claim 1, wherein one of the first and second levels is based upon a sensory array level of human visual perception.

4. The method of claim 1, wherein the first level of mental representation is of a higher order than the second level of mental representation.

5. The method of claim 1, further comprising the step of analyzing the digital image using at least one additional mental representation each mental representation being based upon a level of human visual processing of an image that has not yet been used to analyze the image and determining a perceptual image analysis measure for the image.

6. The method of claim 1, further comprising the step of defining a subject area in the image and wherein one of the steps analyzing the digital image analyzes the digital image in part based upon the defined subject area.

7. The method of claim 1, wherein the step of determining an overall image quality measure comprises the first image quality measure and the second image quality measure using a weighted combination wherein the weights are based upon statistical analysis of user reaction to sample images.

8. A method for evaluating quality of a digital image, the method comprising the steps of:
determining a set of perceptual image analysis representations to be used in evaluating an image with each perceptual image analysis representation being based upon a different level of human image perception;
identifying a set of image elements for use in analyzing the image with respect to each perceptual image analysis representation in the set;
obtaining objectively measurable image features of the identified elements;
analyzing the features obtained for each determined perceptual image analysis representation to determine an image quality measure for each perceptual image analysis representation; and
determining an overall image analysis measure based upon the determined image quality measures.

9. The method of claim 8, further comprising the step of defining a subject area in the image and wherein the step of analyzing the features obtained for at least one of the determined perceptual image analysis representations includes the step of analyzing the features obtained for the at least one determined perceptual image analysis is based upon the defined subject area.

10. The method of claim 8, further comprising the step of converting the digital image into an intermediate form and wherein the step of obtaining the objectively measurable features, comprises obtaining the objectively measurable features from the intermediate form digital image.

11. A computer program product for evaluating the quality of an image, the computer program product comprising a computer readable storage medium having a computer program stored thereon for performing the steps of:
obtaining the image;
analyzing the digital image using a first mental representation based upon a first level of human visual processing of an image to obtain a first perceptual image analysis measure;
analyzing the digital image using a second mental representation based upon a second level of human visual processing of an image to obtain a second perceptual image analysis measure; and
determining an image quality evaluation measure based upon the first perceptual image analysis measure and the second perceptual image analysis measure,
wherein The first and second mental representations are based upon different levels of human visual processing.

12. The computer program product of claim 11, wherein the first level mental representation is based upon at least one of the object and category levels of human visual perception.

13. The method of claim 11, wherein one of the first and second levels is based upon a sensory array level of human visual perception.

14. The method of claim 11, wherein the first level of mental representation is of a higher order than the second level of mental representation.

15. The method of claim 11, further comprising the step of analyzing the digital image using at least one additional mental representation each mental representation being based upon a level of human visual processing of an image that has not yet been used to analyze the image and determining a perceptual image analysis measure for the image.

16. The method of claim 11, further comprising the step of defining a subject area in the image and wherein one of the steps analyzing the digital image analyzes the digital image in part based upon the defined subject area.

17. The method of claim 1, wherein the step of determining an overall image quality measure comprises the first image quality measure and the second image quality measure using a weighted combination wherein the weights are based upon statistic analysis of user reaction to sample images.

18. A computer program product for evaluating quality of a digital image, the computer program product comprising a computer readable storage medium having a computer program stored thereon for performing the steps of:
determining a set of perceptual image analysis representations to be used in evaluating an image with each perceptual image analysis representation being based upon a different level of human image perception;
identifying a set of image elements for use in anaylzing the image with respect to each of the perceptual image analysis representations in the set;
obtaining the objectively measurable image features of the identified elements;
analyzing the features obtained for each determined perceptual image analysis representation to determine an image quality measure for each perceptual image analysis representation; and
determining an overall image analysis measure based upon the determined image quality measures.

19. The computer program product of claim 18, further comprising the step of defining a subject area in the image and wherein the step of analyzing the features obtained for at least one of the determined perceptual image analysis representations includes the step of analyzing the features obtained for the at least one determined perceptual image analysis is based upon the defined subject area.

20. The computer program product of claim 19, further comprising the step of converting the digital image into an intermediate form and wherein the step of obtaining the objectively measurable features, comprises obtaining the objectively measurable features from the intermediate form digital image.
